(19) United States
(12) Patent Application Publication
(10) Pub. No.: US 2010/0293144 A1
(43) Pub. Date: Nov. 18, 2010

(54) USING SNAPSHOTTING AND VIRTUALIZATION TO PERFORM TASKS IN A KNOWN AND REPRODUCIBLE ENVIRONMENT

(76) Inventor: Michael S. Bonnet, Boston, MA (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/466,631

(22) Filed: May 15, 2009

(51) Int. Cl. G06F 12/00; G06F 12/16; G06F 9/445; G06F 9/44

(52) U.S. Cl. 707/640; 717/174; 717/126; 718/1; 711/162; 711/E12.001; 711/E12.103; 707/822; 707/770

(57) ABSTRACT

Some embodiments of using snapshotting and virtualization to perform tasks in a known and reproducible environment have been presented. In one embodiment, a pristine snapshot of a first virtual machine in a computer file system is stored in a computer-readable storage medium. The pristine snapshot represents a known environment. A processor clones the pristine snapshot to generate a copy of the pristine snapshot, and starts a second virtual machine using the copy of the pristine snapshot to reproduce the known environment for executing an operation.

### TECHNICAL FIELD

Embodiments of the present invention relate to computing environment, and more specifically to providing a known and reproducible computing environment using snapshotting and virtualization.

### BACKGROUND

Today, virtualization of computing resources has been gaining popularity because of increased operational flexibility. Broadly speaking, virtualization is emulation of physical hardware. A virtual machine, thus, refers to generally a software implementation of a machine that executes programming instructions to perform operations and tasks as if executed by a physical machine, such as a personal computer. One or more virtual machines may run on a single physical machine. A virtual machine may be a virtual host or a virtual guest. In some conventional systems, the virtual host and the virtual guests are all virtual machines running under the hypervisor, which is a virtualization controller running on the physical machine.

When a virtual machine is started, an appropriate operating system and software tools are installed on the virtual machine in order to allow the virtual machine to perform a particular class of operations. Different classes of operations may require different operating systems and/or tools. However, this process of starting a virtual machine may become burdensome and tedious in the context of software testing because frequently, multiple instances of virtual machines have to be started to test different versions of software. Furthermore, the virtual machines have to be manually set up and checked to ensure that they have the same computing environment. Such a manual process can be tedious and error-prone.

### BRIEF DESCRIPTION OF THE DRAWINGS

The present invention is illustrated by way of example, and not by way of limitation, in the figures of the accompanying drawings and in which:

FIG. 1A illustrates a flow diagram of one embodiment of a method to create a pristine snapshot.

FIG. 1B illustrates a flow diagram of one embodiment of a method to execute an operation in a known and reproducible environment.

FIG. 1C illustrates a flow diagram of one embodiment of a method to test software.

FIG. 2 illustrates a one embodiment of a software testing apparatus.

FIG. 3 illustrates one embodiment of a software deployment system.

FIG. 4 illustrates a block diagram of an exemplary computer system.

### DETAILED DESCRIPTION

Described herein are some embodiments of a method and an apparatus to perform tasks in a known and reproducible environment using snapshotting and virtualization. In one embodiment, a pristine snapshot of a first virtual machine in a computer file system is stored in a computer-readable storage medium. The pristine snapshot represents a known environment because the pristine snapshot captures the configuration of the first virtual machine (including the operating system and tools installed in the first virtual machine), as well as the data in the computing file system. A processor clones the pristine snapshot to generate a copy of the pristine snapshot, and starts a second virtual machine using the copy of the pristine snapshot to reproduce the known environment for executing an operation. More details of some embodiments of the method and apparatus to perform tasks in a known and reproducible environment using snapshotting and virtualization are described below.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required operations. The required structure for a variety of these systems will appear from the description below. In addition, the present invention is not described with reference to any particular programming language. It will be appreciated that a variety of programming languages may be used to implement the teachings of the invention as described herein.

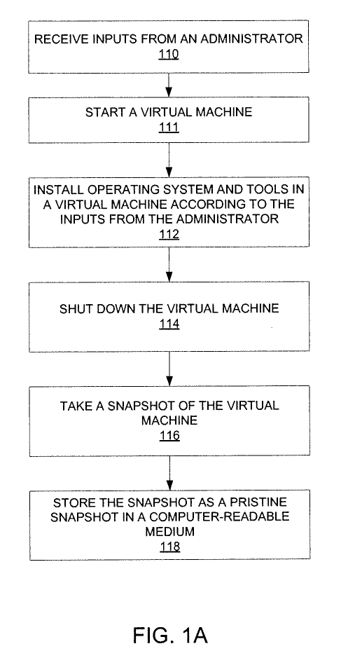

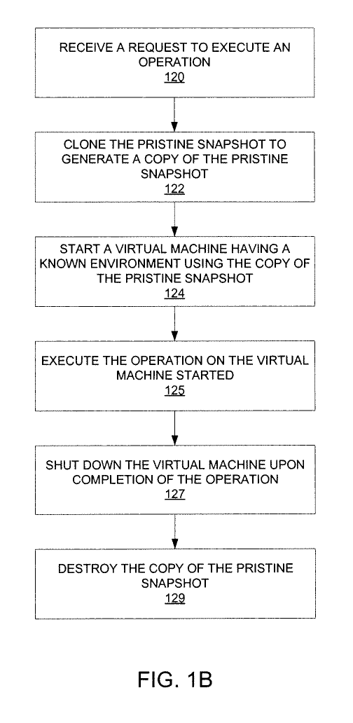

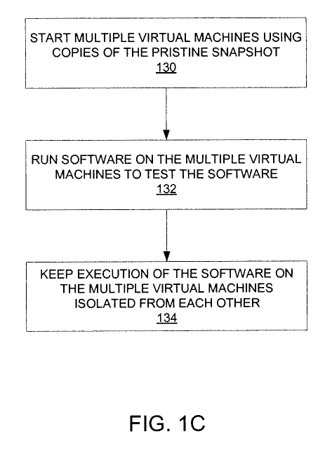

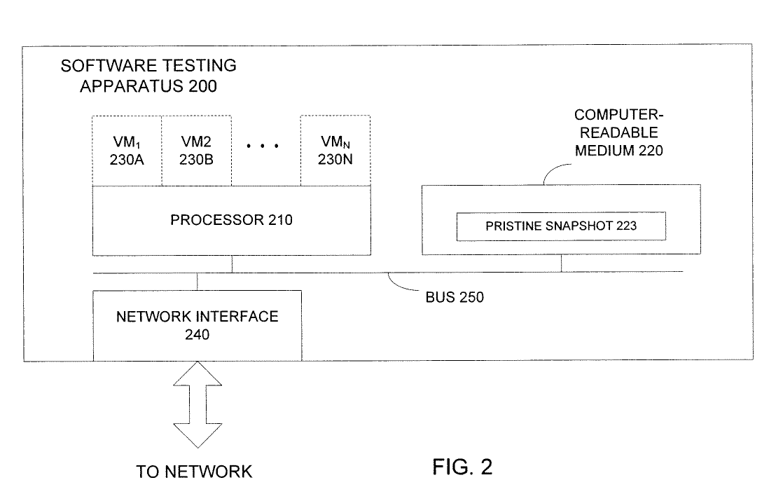

FIG. 1A illustrates a flow diagram of one embodiment of a method to create a pristine snapshot. The method may be performed by processing logic that may comprise hardware (e.g., circuitry, dedicated logic, programmable logic, microcode, etc.), software (such as instructions run on a processing device), firmware, or a combination thereof. For instance, at least part of the method may be performed by the processor 210 illustrated in FIG. 2 in some embodiments.

Initially, processing logic receives inputs from an administrator (processing block 110). The inputs may include instruction on which operating system to install and which tools to install in a virtual machine. As used herein, virtualization broadly refers to emulation of physical hardware, and a virtual machine broadly refers to a software implementation of a machine that executes programming instructions to perform operations and tasks as if executed by a physical machine. A virtual machine may be a virtual host or a virtual guest. Then processing logic starts a virtual machine (processing block 111) and installs an operating system and tools on the virtual machine according to the inputs from the administrator (processing block 112). Then processing logic shuts down the virtual machine (processing block 114).

In some embodiments, processing logic takes a snapshot of the virtual machine (processing block 116). A snapshot includes a point-in-time image of a configuration of the virtual machine, including the operating system and the tools installed, and the data stored in the computer file system hosting the virtual machine. Then processing logic stores the snapshot as a pristine snapshot in a computer-readable medium (processing block 118). A pristine snapshot as used herein refers to a substantially perfect image of the desired configuration of the virtual machine, and the pristine snapshot generally remains unchanged once it is created. The computer-readable medium may include non-removable computer-readable medium (e.g., a hard drive in a server) or removable computer-readable medium (e.g., a flash drive, a CD, etc.). The pristine snapshot may be used later to start other virtual machines in order to reproduce the same computing environment as the virtual machine shut down.

FIG. 1B illustrates a flow diagram of one embodiment of a method to execute an operation in a known and reproducible environment. The method may be performed by processing logic that may comprise hardware (e.g., circuitry, dedicated logic, programmable logic, microcode, etc.), software (such as instructions run on a processing device), firmware, or a combination thereof. For instance, at least part of the method may be performed by the processor 210 illustrated in FIG. 2 in some embodiments.

Initially, processing logic receives a request to execute an operation (processing block 120). The operation may constitute a single task or the operation is part of a task. To prepare for executing the operation, processing logic clones the pristine snapshot to generate a copy of the pristine snapshot (processing block 122). Then processing logic starts a virtual machine with a known environment using the copy of the pristine snapshot (processing block 124). Processing logic executes the operation on the virtual machine started (processing block 125).

Upon completion of the operation, processing logic shuts down the virtual machine (processing block 127) and destroys the copy of the pristine snapshot (processing block 129). Note that during execution of the operation, the computing environment of the virtual machine may be changed as a result of the execution, and hence, the copy of the pristine snapshot used to start the virtual machine may be changed. Therefore, by using the copy of the pristine snapshot instead of the actual pristine snapshot, the actual pristine snapshot can be preserved and protected from changes. As such, the computing environment of every virtual machine started using a copy of the pristine snapshot can be guaranteed to be the same. Furthermore, there is no need to recreate the environment from scratch each time a virtual machine is started. For instance, it is useful in software testing to be able to readily start virtual machines having computing environment that is guaranteed to be the same. The pristine snapshot makes the process of starting multiple virtual machines having the same computing environment more convenient and reliable.

FIG. 1C illustrates a flow diagram of one embodiment of a method to test software. The method may be performed by processing logic that may comprise hardware (e.g., circuitry, dedicated logic, programmable logic, microcode, etc.), software (such as instructions run on a processing device), firmware, or a combination thereof. For instance, at least part of the method may be performed by the processor 210 illustrated in FIG. 2 in some embodiments.

Initially, processing logic starts multiple virtual machines using copies of the pristine snapshot (processing block 130). Because the copies of the pristine snapshot are the same initially, the computing environments of the multiple virtual machines started are the same. Then processing logic runs the software to be tested on these virtual machines (processing block 132). In some embodiments, the software run on the virtual machines may be of different versions. Processing logic keeps the execution of the software on the virtual machines isolated from each other (processing block 134).

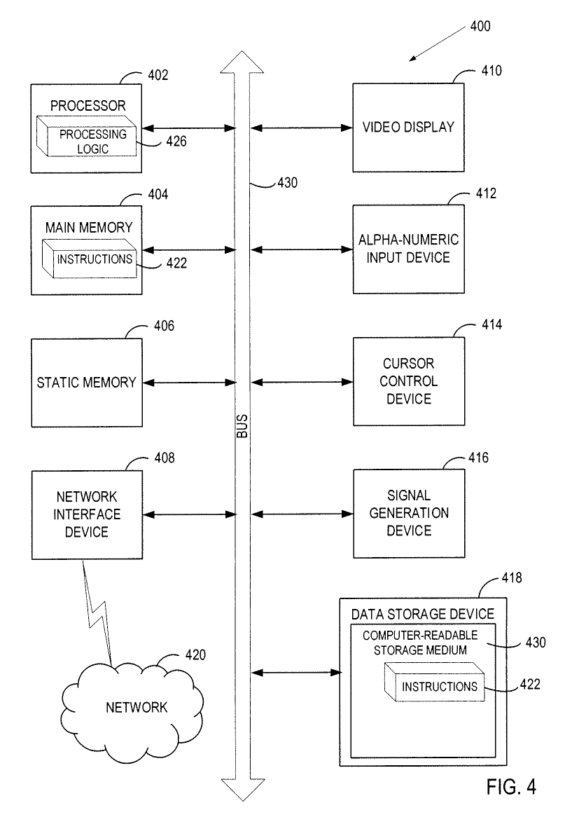

FIG. 2 illustrates one embodiment of a software testing apparatus. The software testing apparatus 200 may be implemented using a computer system (e.g., a server, a personal computer, a workstation, etc.). One exemplary computer system usable to implement personal the software testing apparatus 200 is shown in details in FIG. 4.

In some embodiments, the software testing apparatus 200 includes a processor 210, a computer-readable medium 220, and a network interface 240, coupled to each other via a bus 250. The processor 210 may start one or more virtual machines, such as virtual machines 230a-230n. The virtual machines may or may not be started at the same time, and they may or may not be shut down at the same time.

In order to provide a known and reproducible computing environment for multiple virtual machines, the processor 210 may initially start a virtual machine and install an operating system and one or more tools on the virtual machine according to administrator inputs. Then the processor 210 may shut down the virtual machine and take a snapshot of the virtual machine. The snapshot of the virtual machine is stored in the computer-readable medium 220 as a pristine snapshot 223.

When the processor 210 receives a request to execute an operation, the processor 210 may start a virtual machine using a copy of the pristine snapshot 223. In some embodiments, the processor 210 accesses the pristine snapshot 223 and clones the pristine snapshot 223 by making a copy of the pristine snapshot 223. Note that the actual pristine snapshot 223 in the computer-readable medium 220 remains unchanged. Using the copy of the pristine snapshot 223, the processor 210 starts a virtual machine having the same computing environment as the computing environment of the virtual machine initially started to create the pristine snapshot 223. Then the processor 210 executes the operation on the newly started virtual machine. Note that execution of the operation may change the computing environment of the newly started virtual machine. Therefore, upon completion of the operation, the processor 210 shuts down this virtual machine and destroys the copy of the pristine snapshot 223. In sum, the pristine snapshot 223 allows the processor 210 to readily start virtual machines having a known and reproducible environment without starting from scratch every time.

Using the above approach, the software testing apparatus 200 can test software repeatedly using virtual machines having the known and reproducible environment. Upon completion of testing, the processor 210 may build a final version of the software and deploy (or push) the final version of the software via the network interface 240 to a code repository.

Note that any or all of the components of the software testing apparatus 200 and associated hardware may be used in various embodiments of the present invention. However, it can be appreciated that other configurations of the software testing apparatus 200 may include more or fewer components than those discussed above. The processor 210 and the computer-readable medium 220, etc., are illustrative examples of components in the software testing apparatus 200. One should appreciate that other types of components and/or devices may be included in the software testing apparatus 200 in other embodiments.

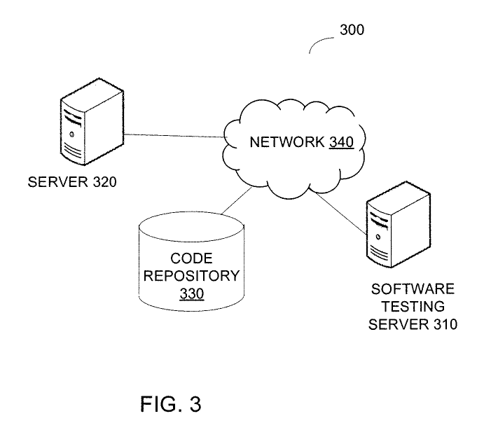

FIG. 3 illustrates one embodiment of a software deployment system. The software deployment system 300 includes a software testing server 310, a server 320, and a code repository 330, coupled to each other via a network 340. The software testing server 310 may be implemented with a software testing apparatus, such as the software testing apparatus 200 shown in FIG. 2. Details of some embodiments of the software testing apparatus have been discussed above. The server 320 may be implemented using a computer system, such as the computer system 400 shown in FIG. 4, which is discussed in details below. The code repository 330 includes one or more databases made of computer-readable media to store programming code, which may include one or more of source code, executable files, object code, etc.

The network 340 may include various types of networks, such as a local area network (LAN), a wide area network (WAN), an intranet, the Internet, etc. The servers 310 and 320 and the code repository 330 are illustrative examples of devices communicatively coupled to the network 340. It should be apparent that various types of devices may communicatively couple to the network 340 in other embodiments, such as a desktop personal computer (PC), a laptop PC, a personal digital assistant (PDA), a mobile telephone, etc.

In some embodiments, the software testing server 310 starts a virtual machine and installs an appropriate operating system and tools on the virtual machine according to administrator inputs. Then the software testing server 310 shuts down the virtual machine and takes a snapshot of the virtual machine. The snapshot is saved as a pristine snapshot on the software testing server 310. Using copies of the pristine snapshot, the software testing server 310 may start multiple virtual machines having the same computing environment. The software testing server 310 may run different versions of software on these virtual machines in order to test the software. After testing the software and finding the software to be of satisfactory quality, the software testing server 310 may push the code of the software to the code repository 330 via the network 340. The code of the software in the code repository 330 may be accessed by other computing machines or computing devices, such as the server 320, via the network 340.

FIG. 4 illustrates a diagrammatic representation of a machine in the exemplary form of a computer system 400 within which a set of instructions, for causing the machine to perform any one or more of the methodologies discussed herein, may be executed. In alternate embodiments, the machine may be connected (e.g., networked) to other machines in a LAN, an intranet, an extranet, and/or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. The processing device 402 is configured to execute the processing logic 426 for performing the operations and steps discussed herein.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a computer-accessible storage medium 430 (also known as a computer-readable storage medium) on which is stored one or more sets of instructions (e.g., software 422) embodying any one or more of the methodologies or functions described herein. The software 422 may also reside, completely or at least partially, within the main memory 404 and/or within the processing device 402 during execution thereof by the computer system 400, the main memory 404 and the processing device 402 also constituting computer-accessible storage media. The software 422 may further be transmitted or received over a network 420 via the network interface device 408.

While the computer-readable storage medium 430 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical and magnetic media, etc.

Thus, some embodiments of performing tasks in a known and reproducible environment using snapshotting and virtualization have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
storing in a computer-readable storage medium a pristine snapshot of a first virtual machine in a computer file system, the pristine snapshot representing a known environment;
cloning, by a processor, the pristine snapshot to generate a copy of the pristine snapshot; and
the processor starting a second virtual machine using the copy of the pristine snapshot to reproduce the known environment for executing an operation.

2. The method of claim 1, further comprising:
the processor using the second virtual machine to execute the operation in the known environment without modifying the pristine snapshot.

3. The method of claim 1, further comprising:
the processor destroying the copy of the pristine snapshot upon shutdown of the second virtual machine.

4. The method of claim 1, wherein the pristine snapshot comprises a point-in-time image of a configuration of the virtual machine and data stored in the computer file system.

5. The method of claim 1, further comprising:
the processor isolating execution of the operation on the second virtual machine from other instances of virtual machines started using other copies of the pristine snapshot.

6. The method of claim 1, further comprising:
the processor testing a software application by repeatedly reproducing the known environment on a plurality of virtual machines and executing the software application on the plurality of virtual machines.

7. The method of claim 1, further comprising:
the processor installing an operating system and a set of one or more software tools in the first virtual machine for executing a predetermined class of operations in response to inputs from an administrator;
the processor shutting down the first virtual machine; and
the processor taking a snapshot of the first virtual machine to create the pristine snapshot.

8. An apparatus comprising:
a computer-readable storage medium to store a pristine snapshot of a first virtual machine in a computer file system, the pristine snapshot representing a known environment; and
a processor coupled to the computer-readable medium, to clone the pristine snapshot to generate a copy of the pristine snapshot and to start a second virtual machine using the copy of the pristine snapshot to reproduce the known environment for executing an operation.

9. The apparatus of claim 8, wherein the processor uses the second virtual machine to execute the operation in the known environment without modifying the pristine snapshot.

10. The apparatus of claim 8, wherein the processor destroys the copy of the pristine snapshot upon shutdown of the second virtual machine.

11. The apparatus of claim 8, wherein the pristine snapshot comprises a point-in-time image of a configuration of the first virtual machine and data stored in the computer file system.

12. The apparatus of claim 8, wherein the processor isolates execution of the operation from other instances of virtual machines started using other copies of the pristine snapshot.

13. The apparatus of claim 8, wherein the processor tests a software application by repeatedly reproducing the known environment on a plurality of virtual machines and executing the software application on the plurality of virtual machines.

14. The apparatus of claim 8, wherein the processor installs an operating system and a set of one or more software tools in the first virtual machine for executing a predetermined class of operations in response to inputs from an administrator, shuts down the first virtual machine, and takes a snapshot of the first virtual machine to create the pristine snapshot.

15. A system comprising the apparatus of claim 8, further comprising:
a first server on which the processor and the computer-readable medium reside.

16. The system of claim 15, further comprising a code repository coupled to the first server via a network, wherein the first server deploys software tested in the known environment using the pristine snapshot to the code repository.

17. A computer-readable storage medium embodying instructions that, when executed by a processor, will cause the processor to perform a method comprising:
storing in a second computer-readable storage medium a pristine snapshot of a first virtual machine in a computer file system, the pristine snapshot representing a known environment;
cloning the pristine snapshot to generate a copy of the pristine snapshot; and
starting a second virtual machine using the copy of the pristine snapshot to reproduce the known environment for executing an operation.

18. The computer-readable storage medium of claim 17, further comprising:
using the second virtual machine to execute the operation in the known environment without modifying the pristine snapshot.

19. The computer-readable storage medium of claim 17, further comprising:
destroying the copy of the pristine snapshot upon shutdown of the second virtual machine.

20. The computer-readable storage medium of claim 17, wherein the pristine snapshot comprises a point-in-time image of a configuration of the first virtual machine and data stored in the computer file system.

21. The computer-readable storage medium of claim 17, further comprising:
isolating execution of the operation on the second virtual machine from other instances of virtual machines started using other copies of the pristine snapshot.

22. The computer-readable storage medium of claim 17, further comprising:
testing a software application by repeatedly reproducing the known environment on a plurality of virtual machines and executing the software application on the plurality of virtual machines.

23. The computer-readable storage medium of claim 17, further comprising:
installing an operating system and a set of one or more software tools in the first virtual machine for executing a predetermined class of operations in response to inputs from an administrator;
the processor shutting down the first virtual machine; and
the processor taking a snapshot of the first virtual machine to create the pristine snapshot.
